(19) United States
(12) Patent Application Publication
(10) Pub. No.: US 2025/0010829 A1
(43) Pub. Date: Jan. 9, 2025

(54) DECENTRALIZED ELECTROHYDRAULIC BRAKE UNIT

(71) Applicant: Robert Bosch GmbH, Stuttgart (DE)

(72) Inventor: Matthias Greiner, Simmozheim (DE)

(21) Appl. No.: 18/586,949

(22) Filed: Feb. 26, 2024

(30) Foreign Application Priority Data
Jul. 3, 2023 (DE) 10 2023 206 297.6

(51) Int. Cl. B60T 13/58; B60T 1/06; B60T 17/22; F16D 55/226; F16D 65/18; F16D 125/06; F16D 127/02

(52) U.S. Cl. CPC B60T 13/588; B60T 1/062; B60T 17/22; F16D 55/226; F16D 65/18; F16D 2125/06; F16D 2127/02; F16D 2200/0034

(57) ABSTRACT

A decentralized electrohydraulic brake unit for braking a wheel of a motor vehicle. The brake unit includes a brake caliper and a brake caliper piston which can be moved axially in the brake caliper via a drive device and via which hydraulic pressure can be applied to a brake piston. A brake pad is disposed on the brake piston. The brake caliper piston and the brake piston are connected to one another via an elastic element, via which the brake piston can actively be retracted after a braking operation.

### CROSS REFERENCE

The present application claims the benefit under 35 U.S.C. § 119 of German Patent Application No. DE 10 2023 206 297.6 filed on Jul. 3, 2023, which is expressly incorporated herein by reference in its entirety.

### FIELD

The present invention relates to a decentralized electrohydraulic brake unit for braking a wheel of a motor vehicle. The present invention also relates to a motor vehicle comprising such a decentralized electrohydraulic brake unit.

### BACKGROUND INFORMATION

In today's vehicle assembly concepts, central brake systems can be used cost-effectively and conveniently. As vehicle electrification increases, the trend is moving toward the use of new brake system concepts. The intent is in particular to configure the brakes in the form of a front axle module and a rear axle module, for instance, or even as four separate brake modules including the wheels. Such a brake system is a decentralized brake system.

U.S. patent No. U.S. Pat. No. 4,406,352 describes an electrically actuated disc brake system for vehicles. The disc brake system comprises a brake caliper in which a spindle drive assembly is disposed. A spindle nut cooperates with a brake cylinder to place a brake pad against a brake disc. A spring is disposed between one end of a spindle of the spindle drive assembly and a shoulder of the brake cylinder, via which the brake cylinder is separated from the brake disc after a braking operation in order to achieve a zero-drag function.

An object of the present invention is to provide an improved decentralized electrohydraulic brake unit.

The object may be achieved by a decentralized electrohydraulic brake unit having features of the present invention. Preferred embodiments of the present invention are disclosed herein.

### SUMMARY

The present invention provides a decentralized electrohydraulic brake unit for braking a wheel of a motor vehicle. According to an example embodiment of the present invention, the brake unit comprises a brake caliper and a brake caliper piston which can be moved axially in the brake caliper via a drive device and via which hydraulic pressure can be applied to a brake piston, wherein a brake pad is disposed on the brake piston. The brake caliper piston and the brake piston are connected to one another via an elastic means (i.e., an elastic element), via which the brake piston can actively be retracted after a braking operation.

Unlike a central electrohydraulic brake unit, the decentralized brake unit generates the brake pressure at each wheel. There is therefore no need to lay hydraulic lines. The brake pressure in the brake unit is applied via the brake caliper piston. The brake pressure can be reduced after a braking operation by retracting the brake caliper piston. The elastic means, which is connected to the brake piston and the brake caliper piston, retracts the brake piston in the same way. The brake piston can thus be separated directly from the brake disc after the braking operation. This avoids grinding of the brake pads on the brake disc and prevents any resulting wear and loss of energy.

In a preferred embodiment of the present invention, a diameter of the brake piston is greater than a diameter of the brake caliper piston. As a result, an axial travel of the brake caliper piston is greater than that of the brake piston. This increases the tensile force produced by the elastic means. Even though a high braking force is generated at the brake piston, the force at the brake caliper piston is significantly smaller than the braking force. It is thus possible to use a smaller motor to move the brake caliper piston. This can reduce the weight on the unsprung wheel and improve ride comfort.

In another preferred embodiment of the present invention, the diameter of the brake caliper piston is 8-15 mm and the diameter of the brake piston is 20-60 mm. Such a diameter of the brake caliper piston enables a very small and cost efficient electric motor with a torque below 1 Nm. The force on the brake caliper piston is therefore low, so that, because of the low loads, a plastic material can be used for a spindle drive unit. Moreover, less stringent tolerances on the components are required.

Preferably, a pressure chamber is disposed between the brake caliper piston and the brake piston, and a pressure sensor via which the pressure of the pressure chamber can be measured is provided. The brake pressure produced by the brake caliper piston can thus be measured. This enables precise regulation of the brake pressure.

In an advantageous further development of the present invention, the elastic means is a spring. A spring has the advantage that it can exert not only a tensile force but also a compressive force. Besides the fact that the brake piston can actively be retracted after a braking maneuver, the brake piston can also be preloaded during a braking maneuver via the spring. This makes it possible to quickly place the brake pad against the brake disc. The brake pad is therefore constantly loaded with either a tensile force or a compressive force. This can prevent rattling of the brake pads, so that the noise caused by the brakes is reduced.

The elastic means is advantageously configured such that, in a rest position, the brake piston is pretensioned in the direction of the brake caliper piston. The brake piston is thus held firmly in the rest position. Rattling caused by the brake pads can therefore be avoided. This significantly reduces the noise caused by the brakes.

In another advantageous embodiment of the present invention, the brake caliper piston is made of a plastic material. Since no high forces act on the brake caliper piston, it is possible to make it from plastic material. The cost and weight for such an electrohydraulic brake unit can thus be reduced.

The present invention also provides a motor vehicle comprising such a decentralized electrohydraulic brake unit. Such a motor vehicle has the above-described advantages and properties.

Embodiment examples of the present invention are shown in the figure and explained in more detail in the following description.

### BRIEF DESCRIPTION OF THE DRAWINGS

FIG. 1 shows a sectional view of a decentralized electrohydraulic brake unit according to an embodiment example of the present invention.

### DETAILED DESCRIPTION OF EXAMPLE EMBODIMENTS

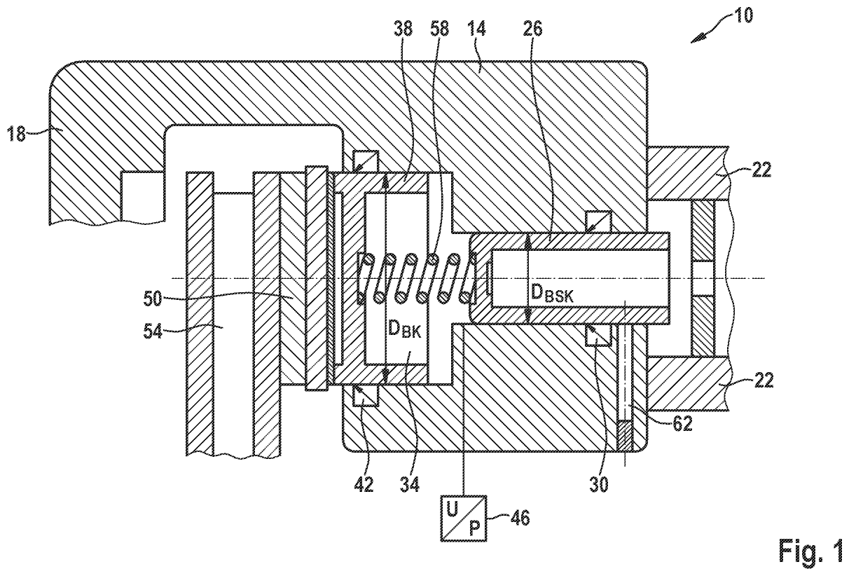

FIG. 1 shows a sectional view of a decentralized electrohydraulic brake unit 10 according to an embodiment example of the present invention. The brake unit 10 comprises a brake caliper 14 and a brake jaw 18 disposed on the brake caliper 14. The figure shows only a part of the brake jaw 18. A drive device 22 configured as an electric motor is disposed on the brake caliper 14, via which a brake caliper piston 26 disposed in the brake caliper 14 is axially movable. The brake caliper piston 26 is sealed by a brake caliper seal 30. The brake caliper 14 forms a pressure chamber 34, in which a brake piston 38 is provided is provided in an axially movable manner. The pressure chamber 34 is sealed to the outside by a brake piston seal 42 which is disposed between the brake piston 38 and the brake caliper 14. The pressure chamber 34 is disposed between the brake caliper piston 26 and the brake piston 38 in the brake caliper 14. The electrohydraulic brake unit 10 also comprises a pressure sensor 46, via which a pressure in the pressure chamber 34 can be measured. A brake pad 50 is attached to the brake piston 38 and can be placed against a brake disc 54 to the brake the motor vehicle.

The brake caliper piston 26 and the brake piston 38 are firmly connected to one another via an elastic means 58, which in this embodiment example is configured as a spring. The spring 58 is disposed coaxially with the brake caliper piston 26 and the brake piston 38. In the embodiment example, it can be seen that a diameter D_{BK} of the brake piston 38 is greater than a diameter D_{BSK} of the brake caliper piston 26. Axial movement of the brake caliper piston 26 is therefore greater than axial movement of the brake piston 38.

Due to the different axial travels of the brake piston 38 and the brake caliper piston 26, it is possible to apply a tensile force to the brake piston 38 after a braking operation via the spring 58. In a rest position, a tensile force is applied to the brake piston 38 so that it is held firmly in said rest position. During the braking operation, on the other hand, a compressive force is applied to the brake piston 38 via the spring 58 so that the brake piston 38 is additionally loaded in the direction of the brake disc 54.

A compensating bore 62 is provided in the brake caliper 14 in the region of the brake caliper piston 26, via which a pressure change caused by the brake caliper piston 26 can be compensated.

What is claimed is:

1. A decentralized electrohydraulic brake unit for braking a wheel of a motor vehicle, comprising:
a brake caliper; and
a brake caliper piston which can be moved axially in the brake caliper via a drive device and via which hydraulic pressure can be applied to a brake piston;
a brake pad disposed on the brake piston;
wherein the brake caliper piston and the brake piston are connected to one another via an elastic element, via which the brake piston can actively be retracted after a braking operation.

2. The decentralized electrohydraulic brake unit according to claim 1, wherein a diameter of the brake piston is greater than a diameter of the brake caliper piston.

3. The decentralized electrohydraulic brake unit according to claim 2, wherein the diameter of the brake caliper piston is 8-15 mm and the diameter of the brake piston is 20-60 mm.

4. The decentralized electrohydraulic brake unit according to claim 1, wherein a pressure chamber is disposed between the brake caliper piston and the brake piston, and a pressure sensor, via which the pressure chamber can be measured, is provided.

5. The decentralized electrohydraulic brake unit according to claim 1, wherein the elastic element is a spring.

6. The decentralized electrohydraulic brake unit according to claim 1, wherein the elastic element is configured such that, in a rest position, the brake piston is pretensioned in a direction of the brake caliper piston.

7. The decentralized electrohydraulic brake unit according to claim 1, wherein the brake caliper piston is made of a plastic material.

8. A motor vehicle, comprising:
a decentralized electrohydraulic brake unit for braking a wheel of a motor vehicle, including:
a brake caliper, and
a brake caliper piston which can be moved axially in the brake caliper via a drive device and via which hydraulic pressure can be applied to a brake piston,
a brake pad disposed on the brake piston,
wherein the brake caliper piston and the brake piston are connected to one another via an elastic element, via which the brake piston can actively be retracted after a braking operation.
